(19) United States
(12) Patent Application Publication
(10) Pub. No.: US 2022/0069464 A1
(43) Pub. Date: Mar. 3, 2022

(54) RECEIVER HAVING A LENS ANTENNA AND ENCODED BEAM DATA

(71) Applicant: Raytheon Company, Waltham, MA (US)

(72) Inventors: Thomas Comberiate, Laurel, MD (US); James McKnight, Baltimore, MD (US)

(73) Assignee: Raytheon Company, Waltham, MA (US)

(21) Appl. No.: 17/010,085

(22) Filed: Sep. 2, 2020

(51) Int. Cl. H01Q 3/38; H04B 7/0408; H04B 7/08; H01Q 15/08

(52) U.S. Cl. CPC H01Q 3/38; H04B 7/0408; G01S 7/03; H01Q 15/08; H04B 7/088

(57) ABSTRACT

Methods and apparatus provide a system having a lens antenna system configured to simultaneously form beams centered at different angles in space within a field of view (FOV) to provide angle of arrival information for each of the beams. The beam data is encoded and combined and digitized. The data is then split into channels for each of the beams and decoded processed.

### FIELD OF THE DISCLOSURE

The present disclosure relates to signal receivers, and more particularly, to signal receivers that encode data.

### BACKGROUND

As is known in the art, radar systems transmit signals and receive signal return to detect targets. Various antenna types and signal processing types can be used. Omnidirectional antennas may cover an entire field of view (FOV) simultaneously, but may not provide angular resolution and may have little antenna gain, and therefore, inferior sensitivity. Interferometers may be used to see over the entire FOV simultaneously and have good angular resolution, but have relatively poor antenna gain, and therefore, inferior sensitivity. Phased arrays need to have many beams to see over the entire FOV simultaneously, which may require a receiver at every element. Such architectures typically have narrow instantaneous bandwidth and are expensive to construct.

### SUMMARY

Embodiments of the disclosure provide methods and apparatus for a radar system including a lens antenna to sample the field of view, where each element on antenna focal plane array may correspond to a high-gain beam centered at a different angle in space. Each angle may be modulated with a different orthogonal code, such as a 1-bit time delay unit, phase shifter, or the like, after which data from the elements are combined and input into a receiver. After these modulated signals are digitized, they may be split into a number of parallel channels (e.g., one for each angle) and decoded with the code corresponding to each angle. The decoding process may reject signals from other angles and pass only the signal from the angle whose code was used. Since each angle has a different parallel stream decoding its code, all angles may be recovered simultaneously.

In embodiments, angle information is encoded using a 1-bit phase shifter or time delay. In other embodiments, a mixer can be used. Encoding is implemented on outputs from a lens focal plane array. Because of this, angles with large signals can be switched off or attenuated without preventing the receiver from seeing signals at other angles.

With this arrangement, the entire field-of-view can be sensed continuously. In embodiments, a 100% probability of detection may be achieved. In addition, a larger antenna gain with better sensitivity can be achieved than with an omnidirectional antenna. Also, angle-of-arrival of a received signal can be determined with more accuracy than an omnidirectional antenna.

Embodiments are applicable to a wide range of applications in which sensing beams simultaneously, for example an entire FOV, is desirable, such as distributed tip and cue sensors, missile altimeters detection over large swaths of land or water, spectrum occupancy monitors, bandwidth usage tracking for optimizing cell phone quality of service, for example.

In one aspect, a system comprises: a lens antenna system configured to simultaneously form beams centered at different angles in space within a field of view (FOV) to provide angle of arrival information for each of the beams; an encoder to uniquely encode data for each of the beams; a combiner to combine the encoded beam data; a receiver to digitize the combined encoded beam data; a splitter to split the combined encoded digitized beam data into channels each corresponding to one of the beams for the different angles; a decoder to decode the encoded beam data from the channels; and a processor to process the decoded beam data.

A system can comprise one or more of the following features: the encoder comprises a one-bit phase shifter for each of the beams, the lens antenna comprises a Luneberg lens, the system is configured to perform angle dependent automatic gain control on the formed beams, the encoder is configured to perform Hadamard coding, the system is configured to reduce sidelobes of the formed beams, the system is configured to selectively attenuate one or more of the beams, the system is configured to detect moving targets, the system is configured to detect bandwidth usage in a cellular phone system, and/or the beams corresponding to angles in the field of view are encoded in the analog domain and decoded in the digital domain.

In another aspect, a method comprises: employing a lens antenna system to simultaneously form beams centered at different angles in space within a field of view (FOV) to provide angle of arrival information for each of the beams; uniquely encoding data for each of the beams; combining the encoded beam data; digitizing the combined encoded beam data; splitting the combined encoded digitized beam data into channels each corresponding to one of the beams for the different angles; decoding the encoded beam data from the channels; and processing the decoded beam data.

A method can further include one or more of the following features: an encoder for the encoding comprises a one-bit phase shifter for each of the beams, the lens antenna comprises a Luneberg lens, performing angle dependent automatic gain control on the formed beams the encoding includes performing Hadamard coding, reducing sidelobes of the formed beams, selectively attenuating one or more of the beams, detecting moving targets in the decoded beam data, detecting bandwidth usage in a cellular phone system from the decoded beam data, and/or the beams corresponding to angles in the field of view are encoded in the analog domain and decoded in the digital domain.

### BRIEF DESCRIPTION OF THE DRAWINGS

The foregoing features of this disclosure, as well as the disclosure itself, may be more fully understood from the following description of the drawings in which:

FIG. 1 shows an example radar system having a receiver system with a lens antenna and encoded beam data in accordance with example embodiments of the disclosure;

FIG. 2 is a schematic representation showing further detail of the receiver system of FIG. 1;

FIG. 3A is a schematic representation of a FOV with beams formed by a lens antenna focal plane array for the system of FIG. 1;

FIG. 3B is a wide FOV element without angle of arrival information for a prior art radar system;

FIG. 3C is a FOV for a prior art scanning AESA with sequentially formed beams wherein a target is missed;

FIG. 3D is a schematic representation of a prior art analog beamforming configuration;

FIG. 3E is a schematic representation of a prior art digital beamforming configuration;

FIG. 4 is an example representation of an example lens antenna and feed system that can form a part of the system of FIG. 1;

FIG. 4A is a top view and FIG. 4B is a side view of lens antenna and feed system that provide beams at various angles defined by azimuth and elevation for a FOV;

FIG. 4C is a schematic representation of a lens antenna and feed array and FIG. 4D is a schematic representation of beams formed by the lens antenna;

FIG. 5 is a waveform diagram showing example codes that can be used to encode beam data;

FIG. 6 is a graphical representation of example signals of interest that may be detected by the system of FIG. 1;

FIG. 7 is a flow diagram showing an example sequence of steps for encoding and decoding beam data from a lens antenna; and

FIG. 8 is a schematic diagram of an example computer that can perform at least a portion of the processing described herein.

### DETAILED DESCRIPTION

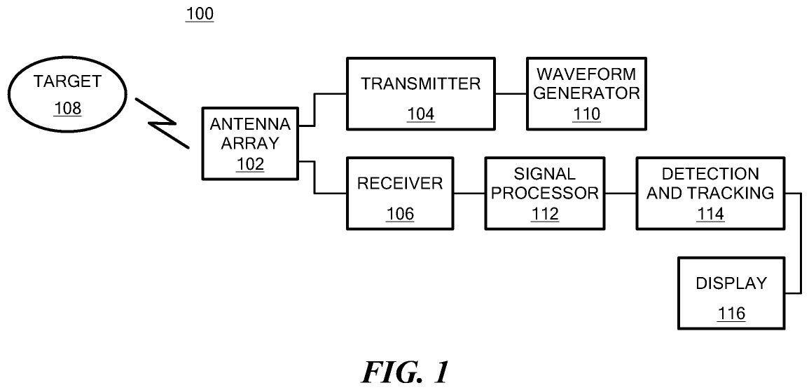

FIG. 1 shows an example radar system 100 having a receiver subsystem with a lens antenna and encoded beam data in accordance with example embodiments of the disclosure. An antenna array 102, such as a lens antenna, is coupled to a transmitter system 104 and a receiver system 106. The radar system 100 can transmit signals that can be reflected by a target 108 and received by the antenna array 102. In some embodiments, the transmitter and receiver systems are physically separate from each other. In some embodiments, the system is passive so that signals are not transmitted—the system is receive only.

A waveform generator 110 can generate signals for the transmitter system 104. Signal return can be received by the receiver system 106 and processed by a signal processor 112. A detection and tracking module 114 is configured to detect and track targets, such as target 108, from the processed signal return. Radar information, which can include target tracking, can be shown on a display 116.

As described more fully below, the lens antenna 102 can form simultaneous beams at selected angles in space and the formed beams for each angle can be encoded and combined. The lens antenna 102 can provide a lens focal plane array (FPA) for the formed beams at the selected angles. The combined data can be separated into channels for each angle and decoded to recover the input signals.

In embodiments, if a transmitted signal is used, it may be omnidirectional so as illuminate the entire field of view in a uniform matter.

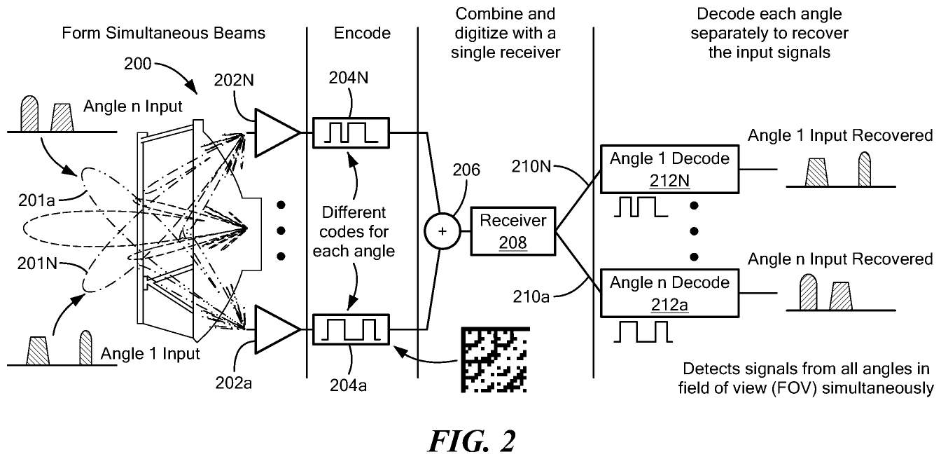

FIG. 2 shows further detail of the system of FIG. 1. A lens antenna 200 forms a number of beams 201a-N simultaneously. For example, beams 201 can be formed for angles 1-N. The lens antenna 200 can be considered a focal plane array (FPA). Each element of the FPA corresponds to a beam centered at a different angle in space. The input for each element can be amplified 202 and provided to a respective encoder 204a-N. In embodiments, the input for each angle/beam is encoded with a unique code, such as a different orthogonal code, e.g., a Hadamard code. In embodiments, encoding is performed with a one-bit time delay unit.

The encoded data for each element is combined in a manifold 206 and input to a receiver 208. The modulated signals are then digitized and split into parallel channels 210a-N, e.g., one channel for each angle. Respective decoders 212a-N receive the channels 210 and decode each channel based on the code for each angle. The signals from other angles are rejected so that only signals from the angle corresponding to the code pass. Since each angle has a different stream decoded in parallel, the data for all angles in the antenna field of view can be recovered simultaneously.

In embodiments, decoding processing comprises a filtering operation where the filter impulse response corresponds to the time complement of the sequence used for encoding for the particular angle of interest. In embodiments, this matched filtering operating is followed by adaptive signal processing that uses some or all of the decoded beams to orthogonalize the signal space. This reduces or removes the impact of large interferers on beams that are not centered on their corresponding angles of arrival.

In embodiments, encoding/decoding is implemented using a one-bit, e.g., 180 degrees, phase shifter. In other embodiments, a mixer can be used for encoding/decoding. It is understood that any suitable mechanism can be used for encoding and decoding of beam data.

With this arrangement, the receiver can sense electromagnetic energy over all angles of a wide field of view, e.g., +/−60 degrees, with high angular resolution and high sensitivity simultaneously. Being able to monitor angles in the FOV simultaneously enables the reception and detection of intermittent signals. High angular resolution enables determination of the angle of arrival of the electromagnetic energy and high sensitivity ensures that the electromagnetic energy can be sensed in the presence of receiver thermal noise.

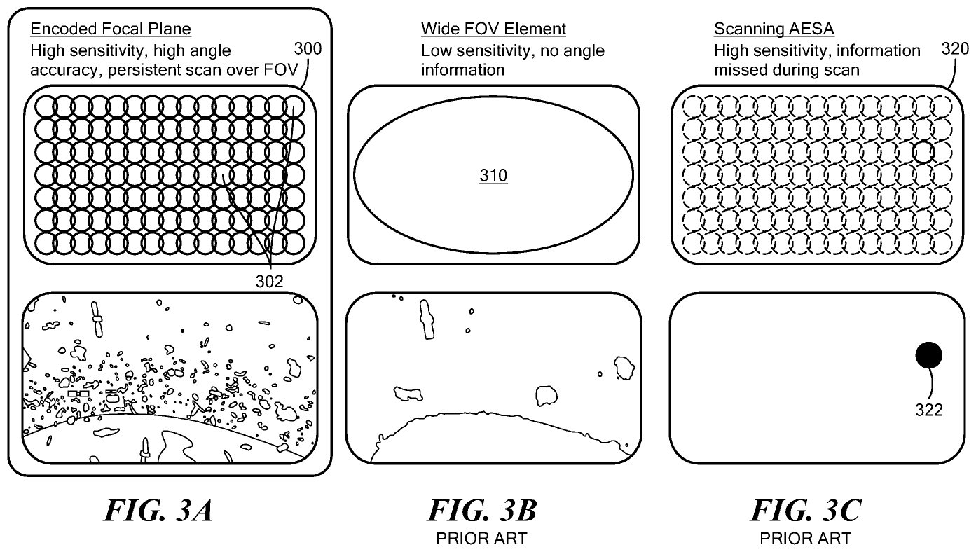

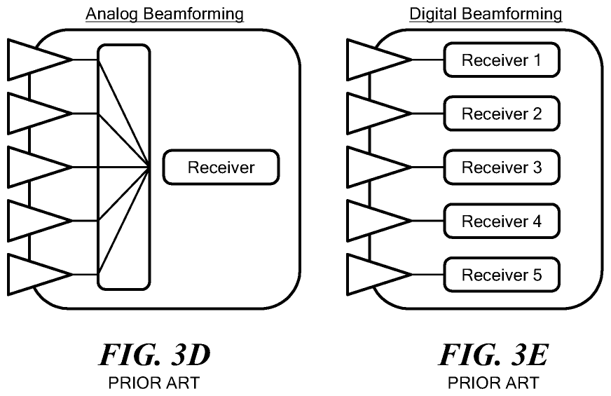

FIG. 3A shows an example encoded focal plane provided by use of the lens antenna and encoding. As can be seen, a series of pencil beams 302 within a FOV 300 are formed simultaneously by the lens FPA. The encoded focal plane forms a high sensitivity, high angle accuracy, persistent scan over the FOV 300. The lower figure shows that the entire field of view can be imaged simultaneously with high sensitivity and high angle accuracy.

FIG. 3B shows a prior art system having a wide FOV 310 with low sensitivity and without angle of arrival information. FIG. 3C shows a prior art scanning AESA FOV 320 with high sensitivity for the formed beams. However, since the pencil beams may be sequentially formed, such as by a phased array radar, a target 322 in the FOV may be missed if not illuminated by a beam at a time at which the target is located within the given beam in the FOV. In each of these cases, it is assumed that the entire field of view is illumined by some intentional or opportunistic emitter. If that is not the case, only the transmitting objects will be seen.

FIG. 3D shows a conventional analog beamforming configuration in which data from multiple beams are provided to a receiver. While this configuration may be low power, the information that can be obtained from the signal return is limited since there are relatively few receivers.

FIG. 3E shows a conventional digital beamforming configuration in which formed beams are provided to respective receivers. The beams can be generated for each element or element subarrays. While significant information can be obtained, the power and cost for such a system is prohibitive.

In embodiments, a system can provide 100% probability of intercept over a given FOV, e.g., ±60° with high sensitivity and angular resolution using a low-SWAP-C (low size, weight, power, and cost) encoded focal plane array. In embodiments, lens antennas can support operation from 1-320 GHz, for example. Instantaneous bandwidth may be limited by encoding, such as a 1-bit 180 degree phase shifter used to perform the encoding. In embodiments, the lens antenna enables angle-dependent automatic gain control to improve system dynamic range.

By encoding beam/angle data, spatial filtering can be performed prior to nonlinear components to allow more effective gain control on the largest interferers that could reduce the dynamic range requirement on the receiver. In embodiments, amplifier gain, such for a low noise amplifier (LNA) can be controlled for each element/beam to optimize dynamic range over the entire FOV.

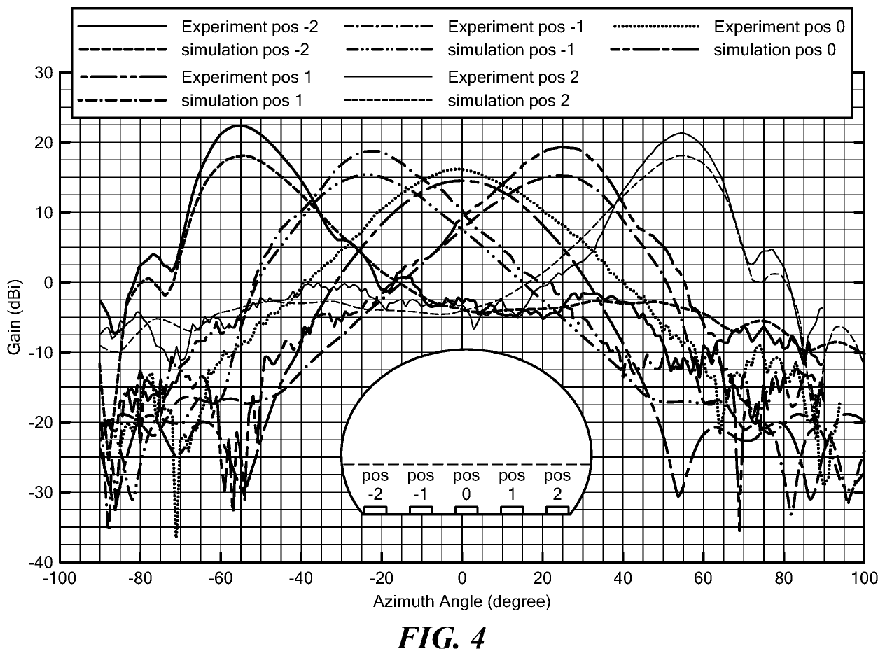

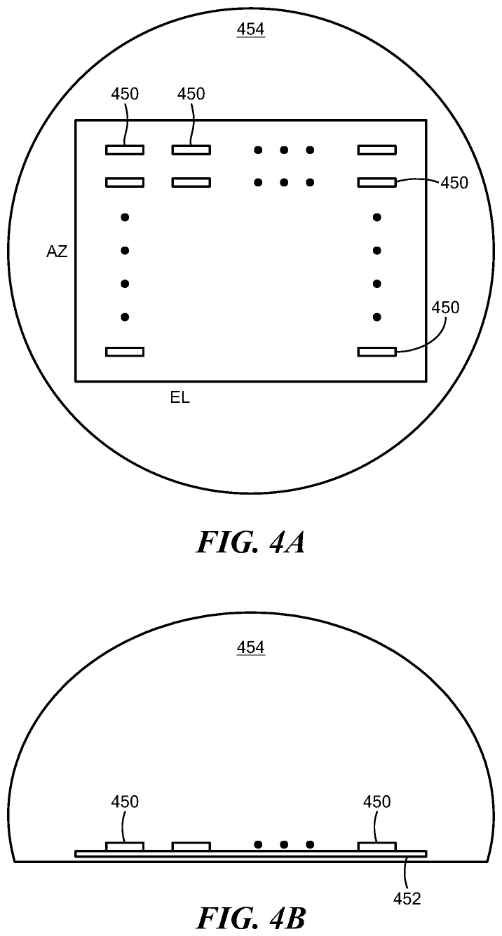

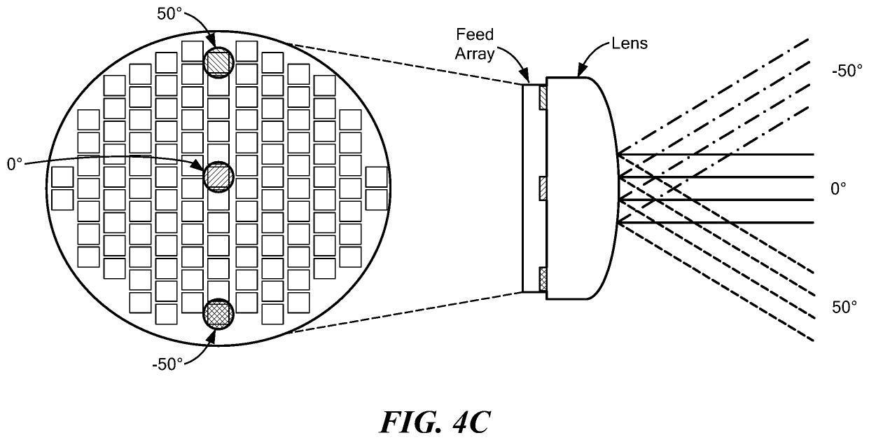

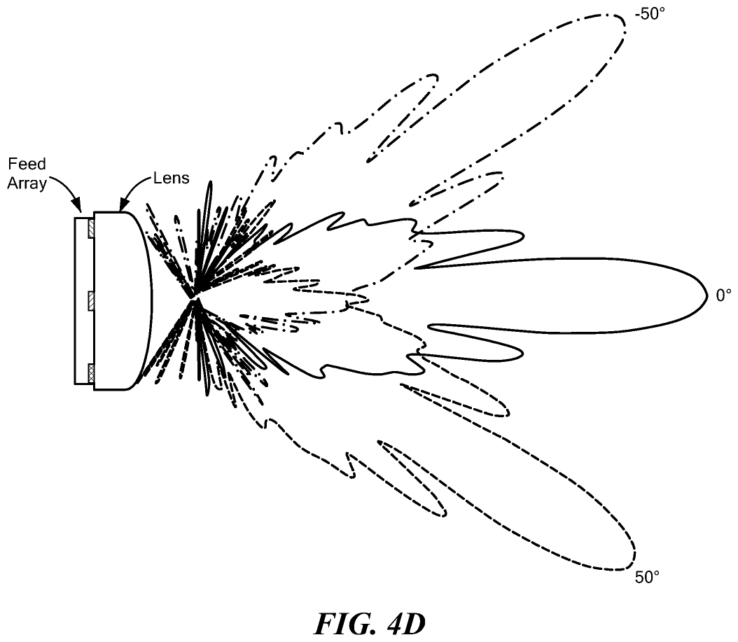

FIG. 4 shows an example lens antenna and feed structure with gain in dBi shown versus azimuth angle for five different feeds for an example lens. In the illustrated embodiment, the lens antenna 400 forms five beams at different feed positions, shown as pos −2, pos −1, pos 0, pos 1, pos 2, where the beams correspond to angles of about −55 degrees, −20 degrees, 0 degrees (broadside), 20 degrees, and 55 degrees, respectively.

FIG. 4A shows a top view and FIG. 4B shows a side view of an example two-dimensional, e.g., azimuth and elevation angle, lens antenna and feed structure. A series of feeds 450 are arranged on a substrate 452 at positions corresponding to respective azimuth/elevation angles formed by a lens 454. The feeds 450 form a focal plane array (FPA), such as the FPA for the FOV 300 of FIG. 3A.

FIG. 4C is a schematic representation of an example lens and feed array. As can be seen, the feed array includes feeds for various angles in space including the illustrated −50 degrees, 0 degrees and 50 degrees. FIG. 4D is a diagrammatic representation of beams formed by the lens antenna including the illustrated −50 degrees, 0 degrees and 50 degrees.

With illustrated arrangement, plane waves are incident on the lens and focused to one of the feed elements. Example farfield patterns produced by the lens are show. It is understood that the device is reciprocal so the patterns would be valid for transmit or receive. Below the lens, the 2D array of feed elements provide scanning functionality over the upper hemisphere (approximately +/−50 degrees). A single array element corresponds to a unique beam position. On receive, the lens takes an incoming plane wave and focuses it onto a single element in the array. By processing all of the beams simultaneously, the entire hemisphere can be covered through high gain, directional beams.

It is understood that spacing between feeds in azimuth and/or elevation directions can be consistent or can vary. The lattice spacing of the feeds can vary in any practical way to meet the needs of a particular application. It is further understood that any practical number of feeds can be used to meet the needs of a particular application.

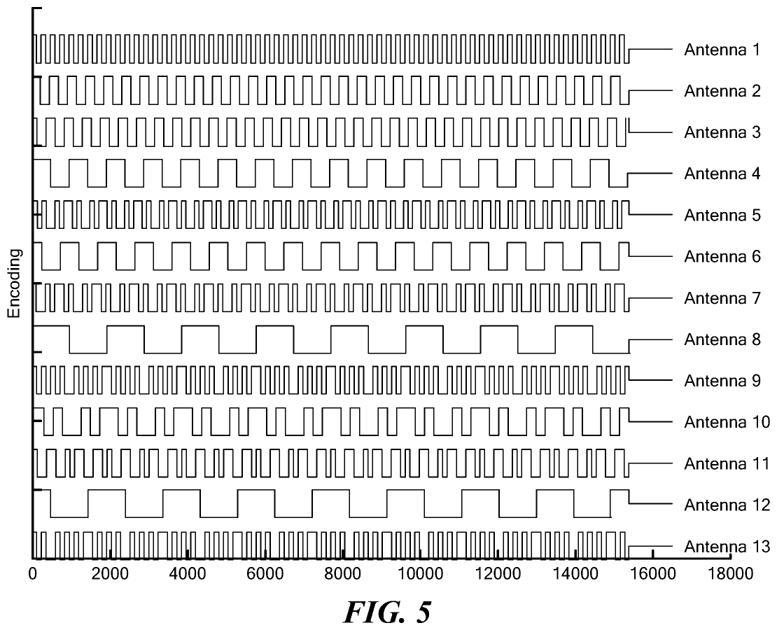

FIG. 5 shows example orthogonal codes that can be used for each angle/beam. In the illustrated embodiment, unique codes are shown for antenna elements 1-13. It is understood that any practical number of elements can be used to meet the needs of a particular application. In example embodiments, Hadamard coding is used. It is understood that any suitable code type can be used.

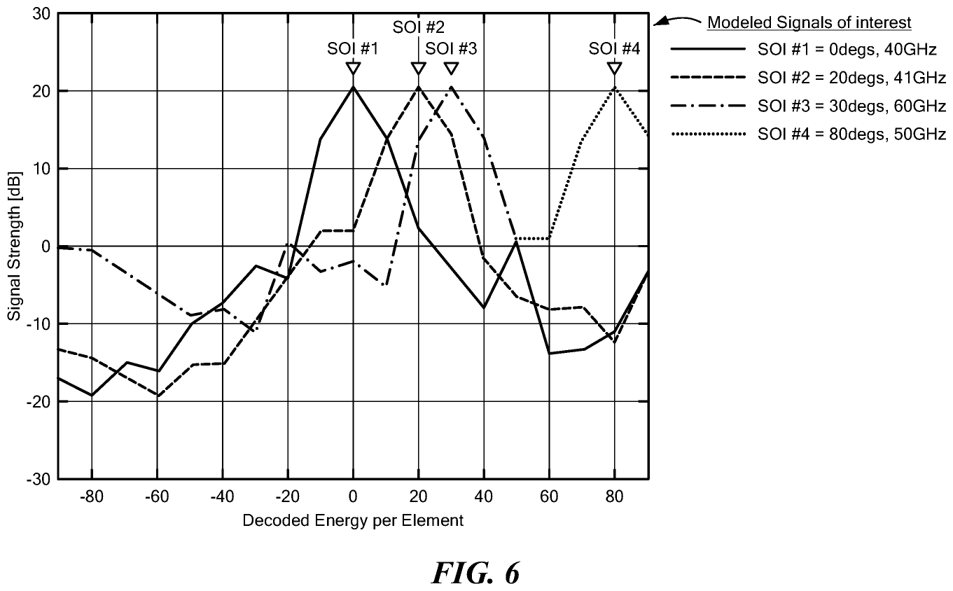

FIG. 6 shows example waveforms for first, second third, and fourth signals of interest (SOI) as dB versus decoded energy per element. In the illustrated embodiment, the first SOI is at zero degrees, the second SOI is at 20 degrees, the third SOI is at 30 degrees, and the fourth SOI is at 80 degrees. The lens antenna, feed elements, encoding device, and receiver may all be designed to span multiple octaves of frequency, as shown in prior art. In this example, they are designed to support a frequency range of 40 to 60 GHz.

While example embodiments of the disclosure and shown and described in conjunction with a radar system, it is understood that embodiments are applicable to detection systems in general in which signal detection in an entire FOV is desirable.

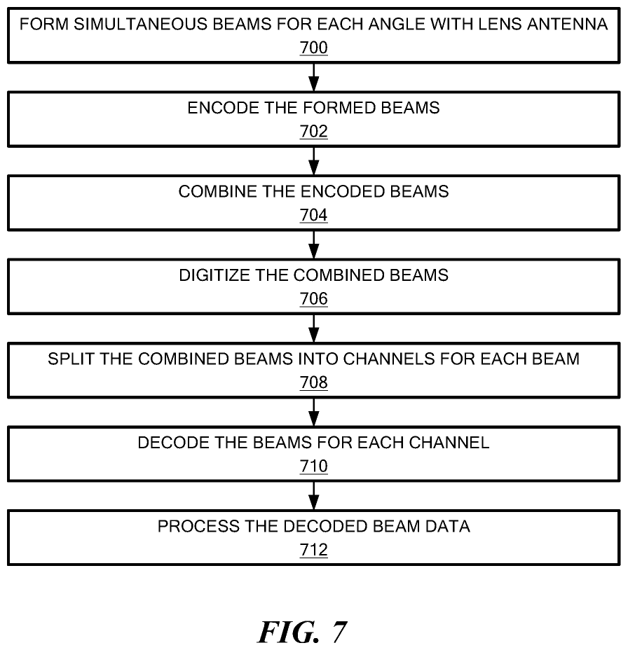

FIG. 7 shows an example sequence of steps for using a lens antenna to form beams for various angles that can be encoded, combined, and decoded, as described above. In step 700, a number of simultaneous beams are formed for given angles in space. In step 702, the formed beams for each angle are encoded, such as with unique orthogonal codes. The encoded beams are combined in step 704 and digitized in step 706. In step 708, the combined digitized beams are split into channels for each beam. In step 710, the beams from each of the channels is decoded. In step 712, the decoded beam data for each angle can be processed.

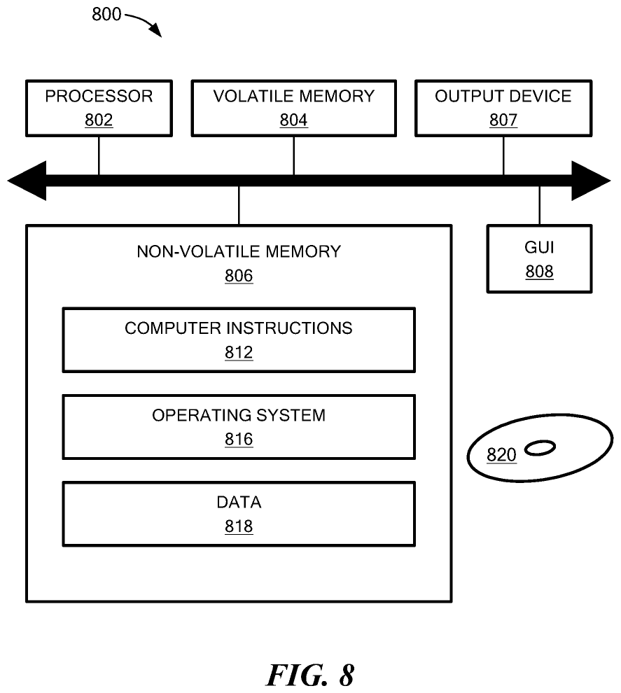

FIG. 8 shows an exemplary computer 800 that can perform at least part of the processing described herein. For example, the computer 800 can perform processing to implement processing in FIGS. 1 and 2, for example, as well as the steps in FIG. 7. The computer 800 includes a processor 802, a volatile memory 804, a non-volatile memory 806 (e.g., hard disk), an output device 807 and a graphical user interface (GUI) 808 (e.g., a mouse, a keyboard, a display, for example). The non-volatile memory 806 stores computer instructions 812, an operating system 816 and data 818. In one example, the computer instructions 812 are executed by the processor 802 out of volatile memory 804. In one embodiment, an article 820 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. [0053]

Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A system, comprising:
a lens antenna system configured to simultaneously form beams centered at different angles in space within a field of view (FOV) to provide angle of arrival information for each of the beams;
an encoder to uniquely encode data for each of the beams;
a combiner to combine the encoded beam data;
a receiver to digitize the combined encoded beam data;
a splitter to split the combined encoded digitized beam data into channels each corresponding to one of the beams for the different angles;
a decoder to decode the encoded beam data from the channels; and
a processor to process the decoded beam data.

2. The system according to claim 1, wherein the encoder comprises a one-bit phase shifter for each of the beams.

3. The system according to claim 1, wherein the lens antenna comprises a Luneberg lens.

4. The system according to claim 1, wherein the system is configured to perform angle dependent automatic gain control on the formed beams.

5. The system according to claim 1, wherein the encoder is configured to perform Hadamard coding.

6. The system according to claim 1, wherein the system is configured to reduce sidelobes of the formed beams.

7. The system according to claim 1, wherein the system is configured to selectively attenuate one or more of the beams.

8. The system according to claim 1, wherein the system is configured to detect moving targets.

9. The system according to claim 1, wherein the system is configured to detect bandwidth usage in a cellular phone system.

10. The system according to claim 1, wherein the beams corresponding to angles in the field of view are encoded in the analog domain and decoded in the digital domain.

11. A method, comprising:
employing a lens antenna system to simultaneously form beams centered at different angles in space within a field of view (FOV) to provide angle of arrival information for each of the beams;
uniquely encoding data for each of the beams;
combining the encoded beam data;
digitizing the combined encoded beam data;
splitting the combined encoded digitized beam data into channels each corresponding to one of the beams for the different angles;
decoding the encoded beam data from the channels; and
processing the decoded beam data.

12. The method according to claim 11, wherein an encoder for the encoding comprises a one-bit phase shifter for each of the beams.

13. The method according to claim 11, wherein the lens antenna comprises a Luneberg lens.

14. The method according to claim 11, further including performing angle dependent automatic gain control on the formed beams.

15. The method according to claim 11, wherein encoding includes performing Hadamard coding.

16. The method according to claim 11, further including reducing sidelobes of the formed beams.

17. The method according to claim 11, further including selectively attenuating one or more of the beams.

18. The method according to claim 11, further including detecting moving targets in the decoded beam data.

19. The method according to claim 11, further including detecting bandwidth usage in a cellular phone system from the decoded beam data.

20. The method according to claim 11, wherein the beams corresponding to angles in the field of view are encoded in the analog domain and decoded in the digital domain.
